(19) United States
(12) Patent Application Publication
(10) Pub. No.: US 2010/0206243 A1
(43) Pub. Date: Aug. 19, 2010

(54) CANINE EXERCISE AND MOBILITY APPARATUS, KIT, AND SYSTEM

(76) Inventor: Maria C. Caiozzo, Portland, OR (US)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 12/388,357

(22) Filed: Feb. 18, 2009

(51) Int. Cl. A01K 15/02; B42D 15/00

(52) U.S. Cl. 119/702; 283/117

(57) ABSTRACT

A canine exercise and mobility product, kit, and system is disclosed. The product may include a reconfigurable canine exercise, and mobility, apparatus. The apparatus may be reversibly reconfigurable between a first configuration and a second configuration. A contact element may be attached to a platform in the first configuration, to contact an underlying surface, and to allow the platform to tilt, and/or to wobble, while the canine stands or leans on the platform. The platform may be configured to be held by human user to control an amount, and/or a rate, of tilt, and/or wobble. A translational element may be attached to the platform in the second configuration to support the platform in a substantially stable manner, and to allow the platform to translate across the surface while supporting at least a portion of the canine's weight.

### BACKGROUND/SUMMARY

Service animals, competitive canines, canine actors and/or family pets are usually very valuable to their owners. Some of these animals may have been given many months of expensive training. These animals sometimes become injured, and/or may become debilitated when old. In addition to, or as part of, the animal's medical, or physical, recovery the animal may also need to recover loss of full balance, agility, and proprioceptive capacity. Proprioceptive losses may refer to the loss of the sense of the position of parts of the body, relative to other neighboring parts of the body.

In addition, canines are often most happy when spending time with his or her owner, or care taker, and may be quite content to simply follow his or her owner around the owner's home. However, if a canine has been injured, or is suffering from a condition such as hip dysplasia, the animal may not be able to move around the owner's home without help. The dog's level of happiness may also affect its health and/or its rehabilitation. Consequently, a canine may be aided, or rehabilitated with the help of a platform which may be translated, i.e. pushed, or pulled, along by uninjured limbs while the other limbs may rest on the platform.

What is needed is a canine exercise and mobility apparatus, kit, and system having the versatility to be used for canine exercise, and for canine mobility. A canine exercise and mobility product, kit, and system is disclosed. The product may include a reconfigurable canine exercise, and mobility, apparatus. The apparatus may be reversibly reconfigurable between a first configuration and a second configuration. The apparatus may include a platform. A contact element may be configured to be attached to the platform in the first configuration to contact an underlying surface, and to allow the platform to tilt, and/or to wobble, while the canine stands or leans on the platform. A translational element may be configured to be attached to the platform in the second configuration to support the platform in a substantially stable manner, and to allow the platform to translate across the surface while supporting at least a portion of the canine's weight. A translational element may also be configured to allow the canine, and/or a human user, to propel the platform across the surface. One or more handles may be coupled with the platform, and may be configured to be held by the human user to enable the human user to control an amount, and/or a rate, of tilt, and/or wobble, of the platform.

It will be understood that a wobble about a single axis may essentially be a tilt. The term wobble may therefore be considered within the context of the present disclosure in either a broader sense, i.e. to include tilting, or a more narrow sense. In some contexts, within the present disclosure, tilting may also be considered as a specific sense of wobbling.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 is a front view of an example canine exercise and mobility apparatus, shown in a first example configuration, in accordance with the present disclosure.

FIG. 2 is a side view of the apparatus shown in FIG. 1.

FIG. 3 is a front view of the apparatus shown in FIGS. 1 and 2, in a second example configuration.

FIG. 4 is a side view of the apparatus shown in FIGS. 1 through 3, in the second example configuration.

FIG. 5 is a front view of the apparatus shown in FIGS. 1 through 4, in another example first configuration.

FIG. 6 is a side view of the apparatus shown in FIGS. 1 through 5, in the example first configuration.

FIG. 7 is a blown up cross-sectional view illustrating an example attachment arrangement in accordance with the disclosure.

FIG. 8 is a cross-sectional view illustrating an example handle that may be used with the apparatus in accordance with the present disclosure.

FIGS. 9 and 10 are schematic views illustrating an example kit in accordance with the disclosure.

FIGS. 11 through 15 are flow diagrams illustrating example methods in accordance with the disclosure.

### DETAILED DESCRIPTION

FIGS. 1 through 5 illustrate an example product in accordance with the present disclosure. The product may include a reconfigurable canine exercise and mobility apparatus 10. The apparatus 10 may be a reversibly reconfigurable between a first configuration such as that shown in FIGS. 1, 2, 5, and 6, and a second configuration, such as that shown in FIGS. 3 and 4. The apparatus 10 may include a platform 12. A contact element 34 or 46 may be configured to be attached to the platform 12 in the first configuration to contact an underlying surface 22, and to allow the platform 12 to tilt and/or to wobble while the canine 5 stands or leans on the platform 12. A translational element 39 may be configured to be attached to the platform 12 in the second configuration to support the platform 12 in a substantially stable manner and to allow the platform 12 to translate across the surface 22 while supporting at least a portion of the canine's weight, and to allow the canine 5 and/or a human user 7 to propel the platform across the surface. One or more handles 24 may be coupled with the platform 12 and may be configured to be held by the human user 7 to enable the human user 7 to control an amount and/or a rate of tilt and/or wobble of the platform 12. In some examples, the handles 24 may be fixed, and not able to rotate. In other examples, the handles 24 may be able to rotate.

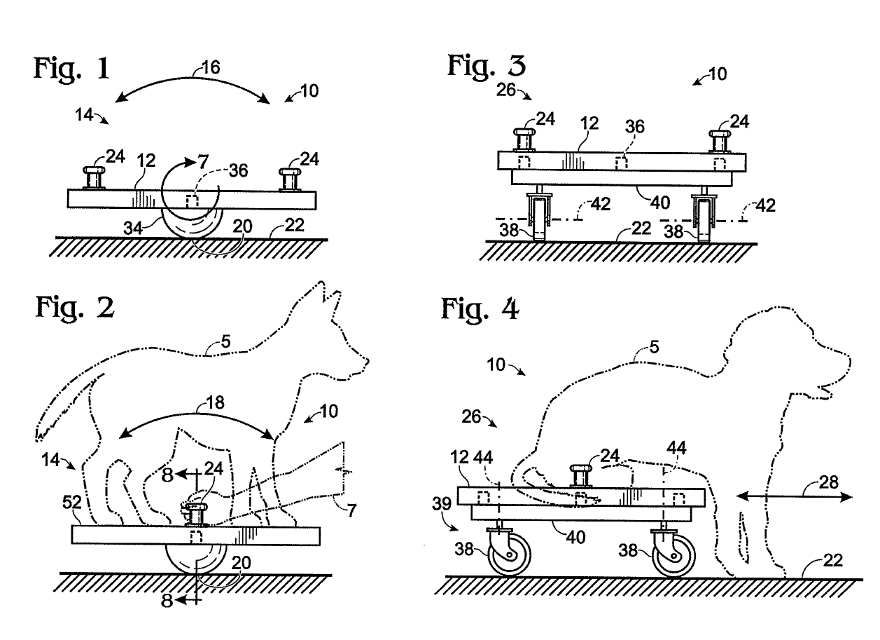

FIG. 1 is a front view of a canine exercise and mobility apparatus 10, and FIG. 2 is a side view of the apparatus 10. The apparatus 10 may include a platform 12. The apparatus 10 is shown in a one example first configuration 14 that may be configured to allow the platform 12 to wobble while the canine 5 stands or leans on the platform 12. The wobble illustrated with arrows 16 and 18 may be, for example, about two orthogonal axes passing through a contact point 20. The contact point 20 may be configured to be in contact with an underlying surface 22.

One or more handles 24, for example two handles 24, may be coupled with the platform 12. The handles 24 may be configured to be held by a human user 7 to enable the human user 7 to control an amount, and/or a rate, of wobble of the platform 12.

FIG. 3 is a front view of the canine exercise and mobility apparatus 10, and FIG. 4 is a side view of the apparatus 10. The apparatus 10 is shown in a second configuration 26 configured to support the platform 12 in a substantially stable manner and configured to allow the platform 12 to translate, as illustrated with arrow 28 across the surface 22 while supporting at least a portion of the canine's weight. In the second configuration 26 the platform 12 may also be configured to allow the canine 5, and/or the human user 7 to propel the platform 12 across the surface 22.

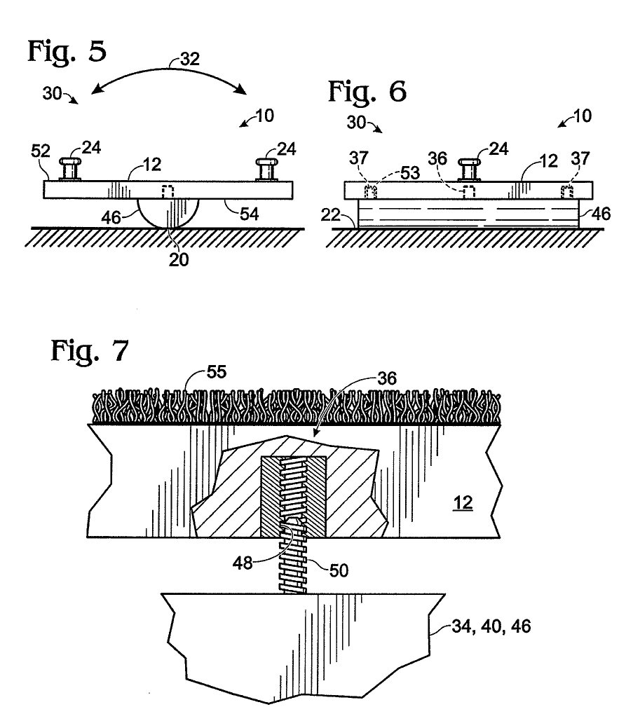

FIG. 5 is a front view of the canine exercise and mobility apparatus 10, and FIG. 6 is a side view of the apparatus 10. The apparatus 10 is shown in another example of a first configuration 30 wherein the apparatus 10 may be configured to allow the platform 12 to tilt while the canine stands or leans on the platform 12. The tilt illustrated with arrow 32 may be, for example about one axis passing through a contact point 20. The handles 24 may also be used to control an amount, and/or a rate, of tilt of the platform 12.

Some example embodiments, according to the disclosure, may enable a canine 5 with one or more problems with one or more limbs to still move around in its environment. For example a canine 5 suffering from hip dysplasia of its rear legs may rest its hind quarters on the platform 12, and may move itself around by pulling itself with its front legs. In this way the canine 5 may have an increased quality of life. In accordance with various example embodiments, the apparatus 10 may be configured to be selectively put into one of many possible first configurations, or one of many possible second configurations.

In various examples the canine 5 may be subjected to a proprioceptive rehabilitation exercise by a human user 7 by tilting or rocking the platform 12 when the point contact element 34, or the linear contact element 46, is attached to the platform 12.

Controlling an amount of tilt, or an amount of wobble, may include holding the platform 12, and preventing the platform 12 from tilting or wobbling at all, controlling a rate of tilt or wobble, and/or actively tilting and wobbling the platform 12. The expression “a substantially stable manner” may be considered to mean supported on the underlying surface 22 so that the platform 12 may not be allowed to tilt, or to wobble, to any significant extent while not being held, or steadied by, the human user 7.

Various examples, in accordance with the disclosure, may enable a single set of elements to be used to rehabilitate the animal by putting the animal through balance, strengthening, and/or proprioceptive exercises, and also as an aid to the animal, and/or human user, to enable translational mobility of the animal within the animal's environment. Having the platform 12, which may be used for balance and strengthening exercises, also readily available at other times may allow the animal to participate in its own rehabilitation—by exercising the limbs it can exercise through self translating—during times when the human user is not able to work with the animal. Further, as the animal ages, the same set of elements used for strengthening and exercise during one stage of the animal's life may be used again in a later stage of the animal's life to provide increased mobility. In addition, since the same platform 12 may be usable in more than one configuration the animal may develop a level of familiarity, and/or comfort, with the platform 12 while using the platform 12 in one configuration, and consequently have more confidence while using the platform 12 in another configuration.

Referring again to FIGS. 1, and 2 the apparatus 12, when in the first configuration 14, may include a point contact element 34 that may be configured to be attached to the platform 12 with an attachment arrangement 36. The point contact element 34 may be, for example, a hemispherical element 34. In various examples the point contact element 34 may include, for example, without limitation, a peg, a cone shaped element, or an oval or oblong shaped element.

The second configuration 26 may include a translation element 39. The translation element 39 may include for example, three or more wheels 38 that may be secured to a base plate 40. The wheels 38 may be configured to rotate about a horizontal axis 42 to facilitate rolling. The wheels 38 may be configured to pivot or rotate about a vertical axis 44 to facilitate easy change of direction on the surface 22. The base plate 40 may be configured to be attached the platform 12 with the attachment arrangement 36. The wheels 38 may be spaced apart and provide a substantially stable support for the base plate 40, and therefore for the platform 12 when the base plate 40 is attached to the platform 12. In some examples the wheels 38 may be attached directly to the platform 12. The wheels 38 may include various wheel types, for example, without limitation, standard wheels, casters, and spherical wheels. In various other examples the translation element 39 may include, for example, one or more low friction elements configured to slide on an underlying surface 22. The low friction elements may include a low friction contact surface that may be, for example, without limitation, plastic, metal or Teflon® or Teflon type material, and the like. The low friction elements may be useful in various environments, for example, homes with carpeting. The low friction elements may be configured to be coupled directly to the platform 12, or to the base plate 40. The low friction elements may, be interchangeable with the wheels 38.

The example first configuration 30 shown in FIGS. 5 and 6 may include a linear contact element 46 that may also be configured to be attached to the platform 12 with the attachment arrangement 36. The linear contact element 46 may be a semi-cylindrical element 46. In some examples of the apparatus 10 the linear contact 46 may instead include two or more point contact elements 34 coupled to a bottom side 54 of the platform 12, arranged collinearly, and configured to contact the surface 22. In this way the apparatus may include, for example two or more hemispherical element 34 that may be used in one configuration, i.e. the first configuration 14 to allow the platform 12 to wobble, and also another configuration, i.e. the third configuration 30, to allow the platform 12 to tilt.

FIG. 7 is a cross-sectional view illustrating an example attachment arrangement 36. The attachment arrangement 36 may be the same for all possible configurations 14, 26 and 30 to facilitate interchangeability of the various elements. An example attachment arrangement 36 may include a threaded hole 48, and a threaded rod 50 configured to threadably engage the threaded hole 48. The threaded rod 50 may be fixed to either the platform 12, or all of the base plate 40, the hemispherical element 34, and the semi cylindrical element 46. Or, alternatively the threaded hole 48 may be included in the other of the platform 12, or all of the base plate 40, the hemispherical element 34, and the semi-cylindrical element 46. In some cases the various elements described herein, or other elements, may be configured to be coupled, or de-coupled by manually rotating one of the base plate 40, the hemispherical element 34, the semi cylindrical element 46, or other elements relative to the platform 12. In other cases a tool may be used to couple, or de-couple the various elements. In some cases the threaded rod 50 may be a machine screw. In other cases the threaded rod 50 may be a wood screw configured to be screwed into either the platform 12, or the base plate 40, the hemispherical element 34, and the semi-cylindrical element 46. In some examples, the threaded hole 48 may be provided with a T-nut screw attached to, or set into, the platform 12.

In other examples other attachment arrangements 36 may be used. For example, the semi-cylindrical element 46 may also include two spaced apart dowels 37 coupled with, and extending from, a flat surface 47 of the semi-cylindrical 46 element. The platform 12 may then be configured to have two spaced apart holes 53 configured to matingly receive the dowels 37 to hold the semi-cylindrical element 46 to the platform 12. A doweling arrangement may also, or instead, be used to hold the hemispherical element 34, or the base plate to the platform 12.

In some examples the one or more handles 24 may be on a top 52 of the platform 12. In some examples the one or more handles 24 may be on one or more sides of the platform 12. If on one or more sides of the platform 12 the one or more handles 24 may include one or more elements configured to extend below the handles 24 a distance great enough to prevent the fingers or knuckles of the human user 7 from being pinched between the surface 22 and the handles 24.

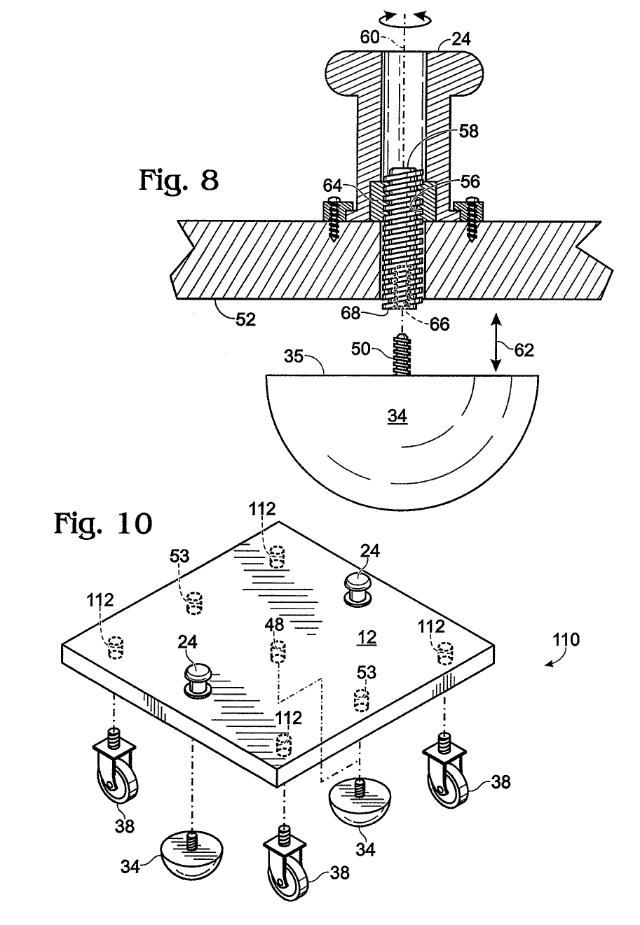

FIG. 8 is a cross-sectional detail of another example handle 24. This example may include one or more of the handles 24 that may be configured to be manipulated to cause one or more extension elements 58 to extend below a bottom surface 54 of the platform 12. This may provide further versatility for the apparatus 10. In this example, the one or more handles 24 may be two handles 24. Each handle 24 may be rotatable, and each handle 24 may include a threaded bore 56 therein. The extension element 58 may be in the form of a threaded rod 58 that may be in threaded engagement within each threaded bore 56. A rotation about a vertical axis 60 of the one or both of the handles 24 may cause a linear movement, illustrated with arrow 62, of the extension element 58 coaxial with the threaded bore 56 to adjustably extend part of the extension element 58 below the bottom surface 54 of the platform. In some examples the threaded bore 56 may be included in a threaded nut 64 fixed to rotate with the handle 24. The nut 64 may, for example, be located within the handle 24.

In one example, with the semi-cylindrical element 46 in place, as shown in FIG. 5, one or two extension elements 58 may be extended below the location of the handles 24 to support the platform 12 to at least partially stabilize it. This may be helpful, for example, when getting the canine to stand on the platform 12. Once on the platform 12, the handles 24 may be manipulated, in this example rotated, to retract the extension elements thereby allowing the platform 12 to tilt about the semi-cylindrical element 46. In another example when the wobble element, i.e. the hemispherical element 34 is in place, two, three, or more extension elements 58 may be extended below the platform 12 to stabilize it.

In another example, the extension elements 58 may be disposed to contact the underlying surface 22 in two spaced apart collinear contact points. This may allow the platform 12 to tilt about the contact points to, for example, rapidly convert the apparatus 10 from a wobbling configuration 14 to a tilting configuration 30. In another example, one extension element 58 may be extended to cause the platform 12 to wobble about an off center point.

In another example the extension elements may be configured to prevent the platform from rolling when the apparatus 10 is in the second configuration 26. In some cases the extension elements 58 may contact the surface 22, and in some cases the extension elements may contact the wheels 38 to prevent them from rolling.

Another example of the one or more extension elements being configured to extend below the bottom surface 54 may include one or more handles that may be fixed to an extension element to form a handle-extension element combination. The handle-extension element combination may have a first lockable position wherein the extension element may extend below the bottom side 54 of the platform 12 an amount sufficient to stabilize the platform 12. The handle-extension element combination may also have a second lockable position wherein the extension element may not extend or may only extend a small amount below the bottom side 54 of the platform 12.

The one or more extension elements 58 may each include a treaded tap 66 at a distal end 68 thereof. One or more of the hemispherical elements 34 may each having a flat surface 35 and a threaded rod 50 connected to and extending from the flat surface 35. The threaded rod 50 may be configured to threadably engage the threaded tap 66. The threaded rod 50 may thus be interchangeably coupled with the one or more extension elements 58 and/or with the hole 48 in the platform 12 as discussed earlier.

The inventor has found that providing the platform with the top surface 52 having preselected qualities may provide a particular level of stimuli to the canine's paw pads that may be advantageous. The top surface may, for example, include a stimulating surface. Certain paw pad stimulation coupled with a gentle controlled tilting, and/or wobbling of the platform 12 to stimulate the semicircular canals of the inner ear, i.e. exercising the canines balance, may provide an effective proprioceptive exercise. The inventor has found that providing a surface, such as a medium ply carpet, or rug, that may, for example, otherwise be suitable as a floor covering may provide a suitable level of stimuli to the canine paw pads. FIG. 7 illustrates how such an example textured surface 55 may appear.

In other examples, other surfaces may be used. Other surfaces may be selected, for example, for their ease of cleaning, and/or keeping clean, and/or sterilizing, and/or keeping sterile. For example a silicone surface may be used. In some examples a material the same, or similar to, an “indoor/outdoor” carpeting may be used. Such material may be substantially easy to clean, and/or to keep clean, and may also provide sufficient proprioceptive feedback. Further, some example embodiments may use surfaces selected to be at least slightly compliant to provide greater comfort to the animal. Some surfaces may be selected for being substantially nonslip but not course enough to cause undue irritation to the animal.

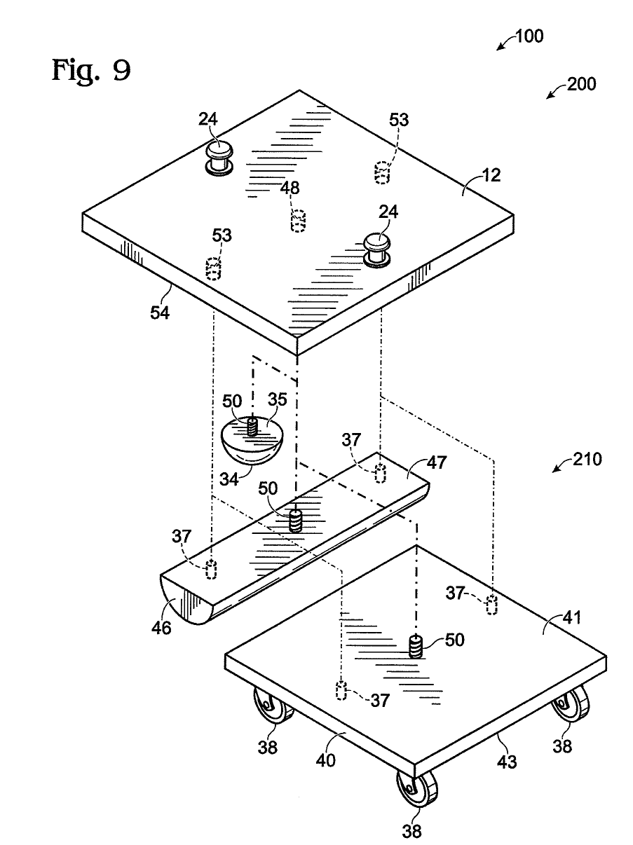

FIG. 9 is a schematic view illustrating an example kit 100 for exercising and providing a transport device for a canine. The kit 100 may include a platform 12 having one or more handles 24. The kit 100 may also include a first element 34 configured to be coupled with the platform 12, wherein the platform 12 may be allowed to wobble when the first element 34 is coupled to the platform 12. The one or more handles 24 may be configured to enable a human user to control an amount of wobble of the platform 12. The kit 100 may also include a second element 46 configured to be coupled with the platform 12. The platform 12 may be allowed to tilt when the second element 46 is coupled to the platform 12. The one or more handles 24 may also be configured to enable the human user to control an amount of tilt of the platform 12. The kit 100 may also include a third element 40 that may be configured to be coupled with the platform 12. The platform 12 may be allowed to be moved across a surface when the third element 40 is coupled to the platform 12.

In some cases, the second element 46 may be a semi-cylindrical element 46 having a flat surface 47. Two spaced apart dowels 37 may be coupled with, and may extend from, the flat surface 47. The platform 12 may have a bottom side 54 that may have two space apart holes 53 configured to matingly receive the dowels 37 to hold the semi-cylindrical element 46 in place relative to the platform 12. In other cases, a threaded rod 40 may be connected to, and may extend from the flat surface 47. The platform 12 may have a bottom side 54 that may have a threaded hole 48 configured to engage the threaded rod 40 to secure the semi-cylindrical element 46 to the platform 12. In cases where the semi-cylindrical element 46 is coupled to the platform 12 via a threaded rod 40, and threaded hole 48, located substantially in the center of the platform 12 the platform may not include holes off center, as the semi-cylindrical element 46 may then not include dowels to be fitted into the off center holes.

The first element 34 may be hemispherical element 34 having a flat surface 35. A threaded rod 50 may be connected to, and may extend from, the flat surface 35. The platform 12 may have a bottom side 54 having a threaded hole 48 configured to engage the threaded rod 50 to secure the hemispherical element 34 to the platform 12.

The base plate 40 may have a first side 41 and an opposite second side 43. A threaded rod 50 may be connected to, and may extend from the first side 41. The platform 12 may having a bottom side 54 having a threaded hole 48 configured to engage the threaded rod 50 to secure the base plate 40 to the platform 12. The base plate 40 may having three or more wheels 38 extending from the second side 43, and may be configured to allow the platform 12, when attached to the base plate 40, to roll on a surface.

FIG. 9 also illustrates some or all of the elements that may be used in an exercise system 200 for an animal. The system 200 may include a platform 12, and a set of selectively interchangeable elements 210 that may be adapted to selectively configure the platform 12 for one of wobbling, tilting, and rolling along a surface. The set of selectively interchangeable elements 210 may be a subset, or a superset of the elements illustrated in FIG. 9. One or more handles 24 may be coupled with the platform 12. The handles 24 may, or may not, include extension elements as described herein.

Some examples may provide a kit with a platform having a bottom side having a threaded hole. A first element may be a hemispherical element having a first element flat surface. A first element threaded rod may extend from the first element flat surface, and may be configured to engage the threaded hole to secure the hemispherical element to the platform. A second element may be a semi-cylindrical element having a second element flat surface. A second element threaded rod may extend from the second element flat surface, and may be configured to engage the threaded hole to secure the semi-cylindrical element to the platform. The kit may also have a third element which may be a base plate. The base plate may have a first side and an opposite second side. A third element threaded rod may extend from the first side, and may be configured to engage the threaded hole to secure the base plate to the platform. The base plate may have three or more wheels extending from the second side, and may be configured to allow the platform, when attached to the base plate, to roll on a surface.

FIG. 10 is a schematic view illustrating another example kit 110 for exercising and providing a transport device for a canine. The kit 110 may include a platform 12 having one or more handles 24. The kit 110 may also include two hemispherical elements 34 that may be configured to be coupled with platform 12 at two spaced apart holes 53, to effect the third configuration 30, or at one center hole 48, to effect the first configuration 14. The kit 110 may also include three or more, in this example four, wheels 38 that may be configured to couple directly to the platform at holes 112 to effect a second configuration.

Various kit configurations may include various numbers of support configurations. For example one kit may include only the elements to allow the platform to tilt and to wobble. Another kit may include only the elements to allow the platform to tilt and to translate. Still another kit may include only the elements to allow the platform to wobble and to translate.

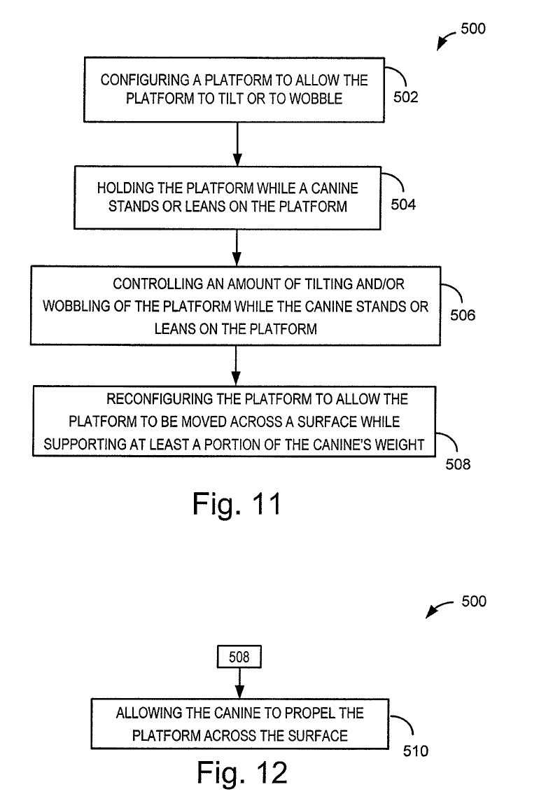

FIG. 11 is a flow chart illustrating a method 500 that may be implemented for providing an exercise and mobility apparatus for a canine. The method 500 may be implemented via the components and systems described above, but alternatively may be implemented using other suitable components. The method 500 may include, at 502, configuring a platform to allow the platform to tilt or to wobble. The method 500 may also include, at 504, holding the platform while the canine stands or leans on the platform. The method 500 may also include, at 506, controlling an amount of tilting and/or wobbling of the platform while the canine stands or leans on the platform. In addition the method 500 may include, at 508, reconfiguring the platform to allow the platform to be moved across a surface while supporting at least a portion of the canine's weight.

FIG. 12 is a flow chart illustrating a variation of the method 500. The method 500 may include, at 510, allowing the canine to propel the platform across the surface.

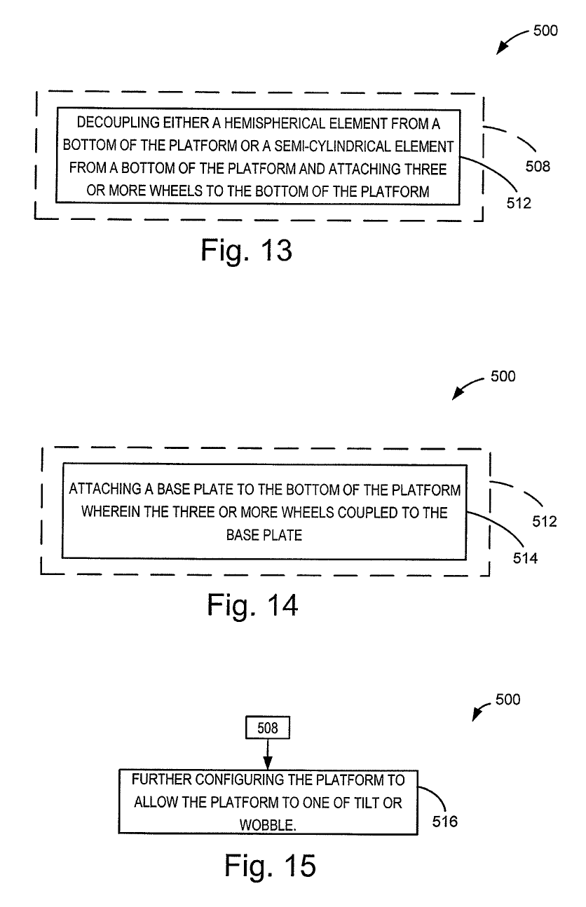

FIG. 13 is a flow chart illustrating variations of the method 500. The reconfiguring 508 shown in FIG. 11 may include, at 512, decoupling either a hemispherical element from a bottom of the platform or a semi-cylindrical element from a bottom of the platform and attaching three or more wheels to the bottom of the platform.

FIG. 14 is a flow chart illustrating variations of the method 500. The attaching three or more wheels to the bottom of the platform include in 512 shown in FIG. 13 may include, at 514, attaching a base plate to the bottom of the platform wherein the three or more wheels coupled to the base plate.

FIG. 15 is flow charts illustrating variations of the method 500. The method 500 may include, at 516, further configuring the platform to allow the platform to one of tilt or wobble. The method 500 may also include detaching the wheels, or the base plate and the wheels, from the platform, and attaching either the hemispherical element or the semi-cylindrical element to the platform.

The following claims particularly point out certain combinations and sub-combinations regarded as novel and non-obvious. These claims may refer to “an” element or “a first” element or the equivalent thereof Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A product comprising:
a reconfigurable canine exercise and mobility apparatus, the apparatus being reversibly reconfigurable between a first configuration and a second configuration, the apparatus including:
a platform;
a contact element configured to be attached to the platform in the first configuration to contact an underlying surface and to allow the platform to tilt and/or to wobble while the canine stands or leans on the platform;
a translational element configured to be attached to the platform in the second configuration to support the platform in a substantially stable manner and to allow the platform to translate across the surface while supporting at least a portion of the canine's weight, and to allow the canine and/or a human user to propel the platform across the surface; and
one or more handles coupled with the platform and configured to be held by the human user to enable the human user to control an amount and/or a rate of tilt and/or wobble of the platform.

2. The canine exercise and mobility apparatus of claim 2, wherein the contact element is either a point contact element configured to be attached to the platform with an attachment arrangement to allow the platform to tilt and to wobble, or a linear contact element configured to be attached to the platform with the attachment arrangement to allow the platform to tilt.

3. The canine exercise and mobility apparatus of claim 2, wherein the point contact element is a hemispherical element and the linear contact element is a semi-cylindrical element.

4. The canine exercise and mobility apparatus of claim 2, wherein the linear contact element includes two or more point contacts coupled to a bottom side of the platform and arranged collinearly and configured to contact the surface.

5. The canine exercise and mobility apparatus of claim 3, wherein the translational element includes three or more wheels secured to a base plate wherein the wheels are configured to pivot about a vertical axis, wherein the base plate is configured to be attached the platform with the attachment arrangement.

6. The canine exercise and mobility apparatus of claim 5, wherein the attachment arrangement includes a threaded hole and a threaded rod configured to threadably engage the threaded hole, wherein the threaded rod is fixed to either the platform or all of the base plate, the hemispherical element, and the semi cylindrical element; and the threaded hole is included in the other of the platform or all of the base plate, the hemispherical element, and the semi cylindrical element.

7. The canine exercise and mobility apparatus of claim 1, wherein the one or more handles are configured to be manipulated to cause an extension element to extend from a bottom surface of the platform to at least partially stabilize the platform while the apparatus.

8. The canine exercise and mobility apparatus of claim 1, wherein the one or more handles are two handles, each handle being rotatable, and each handle including a threaded bore therein, a threaded rod in threaded engagement within each threaded bore, and wherein a rotation of the one or both of the handles causes a linear movement of the threaded rod coaxial with the threaded bore to adjustably extend part of the threaded rod below a bottom surface of the platform.

9. The canine exercise and mobility apparatus of claim 7, wherein the extension element includes a treaded tap at a distal end thereof;
further comprising a hemispherical element having a flat surface and a threaded rod connected to and extending from the flat surface, the threaded rod being configured to threadably engage the threaded tap; and
the platform having a threaded hole located substantially at a center thereof, the threaded hole being configured to threadably engage the threaded rod such that the hemispherical element is interchangeably able to couple with the extension element and with the platform.

10. The canine exercise and mobility apparatus of claim 1, wherein the platform includes a top surface having qualities of a medium ply carpet.

11. A human readable medium comprising:
instructions for configuring a platform to allow the platform to tilt or to wobble;
instructions for holding the platform while a canine stands or leans on the platform;
instructions for controlling an amount of tilting and/or wobbling of the platform while the canine stands or leans on the platform; and
instructions for reconfiguring the platform to allow the platform to be moved across a surface while supporting at least a portion of the canine's weight.

12. The medium of claim 11, further comprising instructions for allowing the canine to propel the platform across the surface.

13. The medium of claim 11, wherein the instructions for reconfiguring includes instructions for decoupling either a hemispherical element from a bottom of the platform or a semi-cylindrical element from the bottom of the platform, and instructions for attaching three or more wheels to the bottom of the platform.

14. The medium of claim 13, wherein the instructions for attaching three or more wheels to the bottom of the platform includes instructions for attaching a base plate to the bottom of the platform wherein the three or more wheels are coupled to the base plate.

15. The method of claim 11, further comprising instructions for further configuring the platform to allow the platform to one of tilt or wobble.

16. A kit for exercising and providing a transport device for a canine comprising:
a platform having one or more handles;
a first element configured to be coupled with the platform, the platform being allowed to wobble when the first element is coupled to the platform, the one or more handles being configured to enable a human user to control an amount of wobble of the platform;
a second element configured to be coupled with the platform, the platform being allowed to tilt when the second element is coupled to the platform, the one or more handles being configured to enable the human user to control an amount of tilt of the platform; and
a third element configured to be coupled with the platform, the platform being allowed to be moved across a surface when the third element is coupled to the platform.

17. The kit of claim 16, wherein the third element is a base plate, the base plate having a first side and an opposite second side, a threaded rod connected to and extending from the first side, the platform having a bottom side having a threaded hole configured to engage the threaded rod to secure the base plate to the platform, the base plate having three or more wheels extending from the second side and configured to allow the platform, when attached to the base plate, to roll on a surface.

18. The kit of claim 16, wherein the platform has a bottom side having a threaded hole;
wherein the first element is a hemispherical element having a first element flat surface, a first element threaded rod extending from the first element flat surface and configured to engage the threaded hole to secure the hemispherical element to the platform;
wherein the second element is a semi-cylindrical element having a second element flat surface, a second element threaded rod extending from the second element flat surface and configured to engage the threaded hole to secure the semi-cylindrical element to the platform; and
wherein the third element is a base plate, the base plate having a first side and an opposite second side, a third element threaded rod extending from the first side and configured to engage the threaded hole to secure the base plate to the platform, the base plate having three or more wheels extending from the second side and configured to allow the platform, when attached to the base plate, to roll on an underlying surface.

19. An exercise system for an animal comprising:
a platform having a threaded hole located substantially at a center of a bottom of the platform, the platform having two spaced apart holes on the bottom;
handles on the platform sized and shaped to be held by a human user;
a hemispherical element having a flat surface, a hemispherical element threaded rod extending from the flat surface and matingly threadable with the threaded hole to detachably couple the hemispherical element with the platform;
a semi-cylindrical element including two spaced apart dowels sized and shaped to mate with the two spaced apart holes on the bottom of the platform to detachably couple the semi-cylindrical element to the platform; and
a base plate having a plate threaded rod extending from a first side thereof, the threaded rod matingly threadable to the threaded hole on the bottom of the platform to detachably couple the base plate with the platform, three or more wheels attached to a second side of the base plate.

20. The exercise system of claim 19, further comprising one or more handles coupled with the platform.
